(19) United States
(12) Patent Application Publication
(10) Pub. No.: US 2009/0259757 A1
(43) Pub. Date: Oct. 15, 2009

(54) Securely Pushing Connection Settings to a Terminal Server Using Tickets

(75) Inventors: Ido Ben-Shachar, Kirkland, WA (US); Meher P. Malakapalli, Sammamish, WA (US); Donghang Guo, Bellevue, WA (US); Ashwin Palekar, Sammamish, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/103,542

(22) Filed: Apr. 15, 2008

(51) Int. Cl. G06F 15/16

(52) U.S. Cl. 709/228

(57) ABSTRACT

Systems and techniques for securely pushing connection settings to a terminal server using tickets are described. In one embodiment, a request is received at a first network component from a client for access to a second network component. A ticket associated with one or more connection settings is created and provided to the client. The ticket is provided by the client to the second network component. The ticket is provided from the second network component to the first network component, and the one or more connection settings associated with the ticket are received from the first network component back to the second network component. The one or more connection settings are enforced at the second network component.

### BACKGROUND

Terminal servers are typically special purpose computers that are used to connect a number of client devices to one or more hosts or servers. Terminal servers may be particularly configured to facilitate communications between various components of a network. For example, a terminal service (TS) system may allow a TS client to interact with an application being run on a remote TS server, providing a user the same experience that would be provided if the application were implemented locally by the TS client. Networks having many clients (e.g. corporations, universities, etc.) may require groups of terminal servers (or “TS farms”) to provide the desired capability.

A typical network deployment may involve multiple servers configured to perform different tasks. For example, a Terminal Server (TS) may host a variety of software applications that are available for use by a variety of different authorized client devices having access to the network. A TS Gateway may be responsible for enabling authorized remote users to connect to the network (e.g. internal corporate network, private network, etc.) from an Internet-connected device, while a TS License server may host information regarding which of the client devices accessing the network are licensed to access the various software applications that are available on the Terminal Server.

During a connection by a client device to the network, several of these servers may want to “weigh in” on whether certain features or capabilities available within the network are authorized for a particular connection. For example, the TS Gateway server may request that a “drive redirection” capability be disabled for certain connections (e.g. where the client device fails a client-side quarantine check), or the TS License server may restrict certain individuals or classes of connections (e.g. per-device license, per-user license, etc.) from accessing resources on the network. Conventionally, to effect such restrictions, the components of the network (e.g. TS Gateway, TS License, etc.) separately communicate with a client-side communication package to push settings to the package that are intended to be enforced in a session. Each of the various components of the network may communicate with the client device using a separate custom protocol. Although such conventional techniques may achieve desirable results for most connections, there is room for improvement.

### SUMMARY

The present disclosure is directed to systems, techniques, and apparatuses for securely pushing connection settings to a terminal server using tickets. Generally, implementations in accordance with the present disclosure provide a centralized capability for establishing and maintaining settings which control a connection's ability to utilize or access network resources within a computer network. Such implementations may advantageously improve network security, improve the uniformity of network communications, and improve the overall efficiency and robustness of the network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the use of the same reference numbers in different figures indicates similar or identical items.

FIG. 1 illustrates an exemplary network for implementing techniques for securely pushing connection settings to a terminal server using tickets in accordance with an implementation of the present disclosure.

FIG. 2 shows an exemplary computing device configured for implementing techniques in accordance with the present disclosure.

FIG. 3 shows a process of securely pushing connection settings to a terminal server using tickets in accordance with another implementation of the present disclosure.

FIG. 4 shows the exemplary network of FIG. 1 operating in accordance with an exemplary implementation of the process of FIG. 3.

FIG. 5 shows a process for creating a ticket in accordance with an implementation of the present disclosure.

### DETAILED DESCRIPTION

Systems, techniques, and apparatus for securely pushing connection settings to a terminal server using tickets are disclosed herein. Generally, embodiments of systems, techniques, and apparatus in accordance with the present disclosure provide a single, centralized capability to publish and control access to network resources within a computer network, without regard for the particular publishing technologies used by the various components of the network. Unlike conventional techniques, which publish connection settings by pushing them to a TS client (often using multiple communication protocols), and which compile individual controls into an allow list for configuration at each terminal server (resulting in multiple allow lists), embodiments in accordance with the present disclosure configure connection settings centrally into a ticket, and then push the ticket as needed to the terminal server of the network for enforcement. Thus, rather than having multiple allow lists scattered throughout a network pertaining to network resources, the administration of network resources in accordance with the present disclosure is controlled by a centralized capability.

Embodiments in accordance with the present disclosure may advantageously provide a more secure or enforceable solution against malicious connections in comparison with the conventional techniques, which may in some circumstances permit a bad or hacked client device connection to overcome the requests from the network components and still invoke the features or capabilities (e.g. drive redirection) that are intended to be prohibited, particularly since the TS Gateway using conventional techniques may be unable to enforce desired restrictions when the traffic between the client device and the network components (e.g. Remote Desktop Protocol traffic) is encrypted. Thus, embodiments in accordance with the present disclosure may improve the efficiency of resource administration activities, the consistency of network resource privileges, and the overall robustness of the computer network.

Exemplary Environment and System

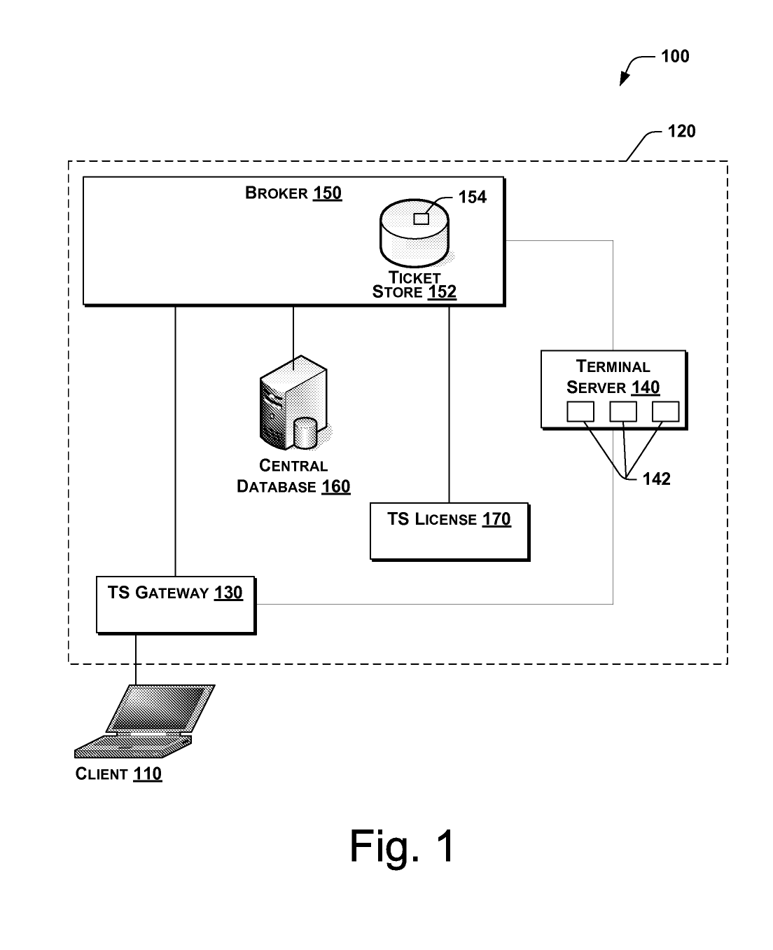

FIG. 1 illustrates an exemplary environment 100 for implementing techniques for securely pushing connection settings to a terminal server using tickets in accordance with at least one implementation of the present disclosure. In the environment 100, a client 110 accesses a network 120 through a gateway server 130 that operatively communicates with a terminal server 140 and a broker 150. The broker 150 operatively communicates with a central database 160 and a license server 170. Of course, the network 120 may include a wide variety of additional components, and is not limited to the particular network implementation shown in FIG. 1.

The broker 150 may host a ticket store 152 that may be configured to create a ticket 154 associated with a particular connection session between the client 110 and the network 120, as described more fully below. Similarly, the terminal server 140 may host a variety of resources 142 that the client 110 may desire to access during the connection session. As used herein, the term “resources” may include applications, patches, upgrades, desktops, directories, documents, images, data, or any other suitable resources that may be installed and shared to multiple entities throughout a network environment.

Generally, the broker 150 may be configured to perform administrative functions associated with authorizations and privileges of clients 110 accessing the network 120. For example, the broker 150 may promulgate policy and configuration information, license restrictions (e.g. per-device license, per-user license, etc.), and any other suitable restrictions. The central database 160 may store information and settings relating to the network 120 in a central, organized database accessible by the broker 150.

Although the client 110 is depicted in FIG. 1 as a laptop computer, in various alternate embodiments, the client 110 may be a server, a workstation, a desktop computer, tablet computer, personal data assistant (PDA), cell phone, media drive, or any other suitable type of device. As used in the present disclosure, the term “client” is intended to include all devices that can host or run software, regardless of whether a person is present or involved in the operation of the device.

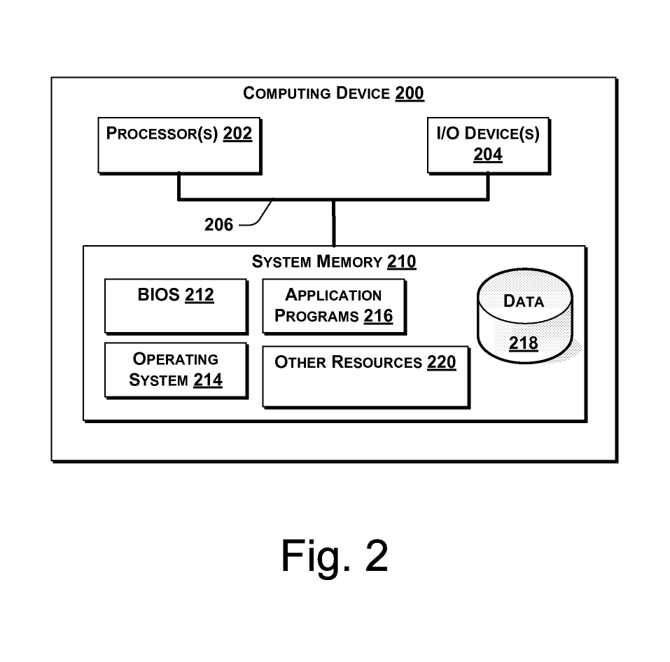

FIG. 2 shows an exemplary computing device 200 configured for implementing techniques in accordance with the present disclosure. It will be appreciated that the computing device 200 may be suitable for use as the client 110, the gateway server 130, the terminal server 140, the broker 150, and the central database 160.

In this embodiment, the computing device 200 may include one or more processors 202 and one or more input/output (I/O) components 204 (e.g., keyboard, mouse, transmitter, receiver, communication ports and associated circuitry, etc.) coupled to a system memory 210 by a bus 206. The bus 206 may represent any of the several types of bus structures, including a memory bus or memory controller, a peripheral bus, an accelerated graphics port, and a processor or local bus using any of a variety of bus architectures.

The system memory 210 may include any suitable type of memory. More specifically, the system memory 210 may include computer-readable media configured to store data and/or program modules for implementing the techniques disclosed herein that are immediately accessible to and/or presently operated on by the processor(s) 202. For example, in the embodiment shown in FIG. 2, the system memory 210 stores a basic input/output system (BIOS) 212, an operating system 214, one or more application programs 216, and program data 218 that can be accessed by the processor(s) 202 and other components stored in the system memory 210. In the case of the terminal server 140, the applications programs 216 and the program data 218 may represent one or more of the resources 142 that are hosted by the terminal server 140. Other resources 220 may also be stored within the system memory 210.

The computer-readable media included in the system memory 210 can be any available media that can be accessed by the device 200, including computer storage media and communication media. Computer storage media include both volatile and nonvolatile, removable and non-removable media implemented in any method or technology for storage of information such as computer-readable instructions, data structures, program modules, or other data. More specifically, suitable computer storage media include random access memory (RAM), read only memory (ROM), electrically erasable programmable ROM (EEPROM), flash memory or other memory technology, compact disk ROM (CD-ROM), digital versatile disks (DVD) or other optical disk storage, magnetic cassettes, magnetic tape, magnetic disk storage or other magnetic storage devices, or any other medium, including paper, punch cards and the like, which can be used to store the desired information.

Similarly, communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

Generally, program modules executed on the exemplary computing device 200 (FIG. 2) may include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

Exemplary Processes

Exemplary processes for secure deployment of software to host devices will now be described. For convenience, and to facilitate an understanding of these processes, the exemplary processes will be described with reference to the exemplary environment 100 and exemplary components described above and shown in FIGS. 1 and 2.

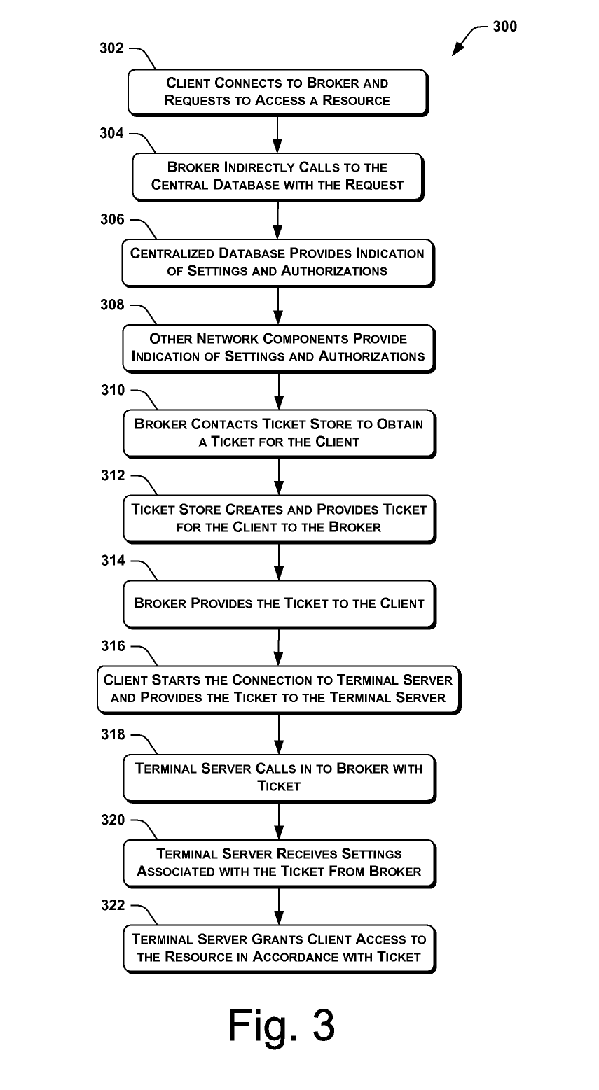

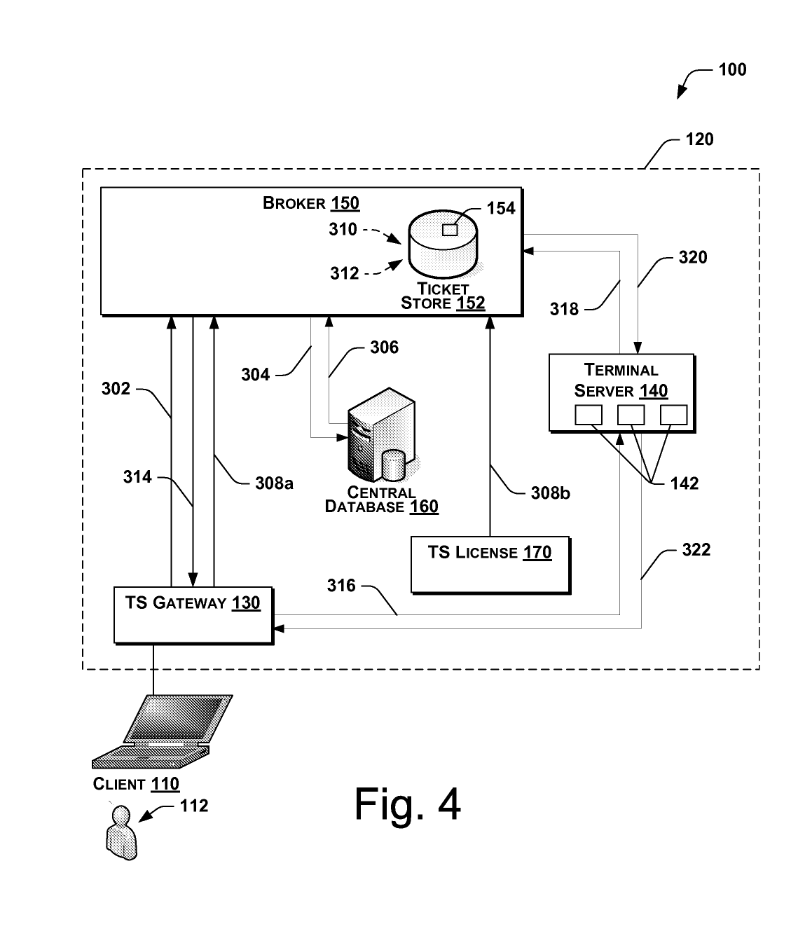

FIG. 3 shows an example process 300 of securely pushing connection settings to a terminal server using tickets in accordance with an implementation of the present disclosure. FIG. 4 shows the exemplary environment 100 of FIG. 1 operating in accordance with the method 300 of FIG. 3. At 302, the client 110 connects to the broker 150 and requests to access one or more of the resources 143 on the terminal server 140. For example, the client 110 (or end-user 112) may request to launch an application (e.g. a word-processing program, a computer-aided design package, a spreadsheet, an accounting package, a data analysis package, a viewer, a data file, a direction-finding program, or any other suitable application) using a remote procedure call (RPC). The request (at 302) from the client 110 may indicate that it is a connection from within the network 120 (e.g. from within an intranet) or from outside the network 120 (e.g. from the internet). In some embodiments, if the client 110 is outside the network 120, the request (at 302) may pass through a gateway 130 as shown in FIG. 4. In addition, the request may specify that Remote Data Protocol (RDP) features not be restricted for this connection. In some implementations, the request to the broker 150 causes the broker 150 to add a new record into the ticket store 152. The record may be a mapping from a set of standard (or default) connection settings to a set of specific connection settings to enforce on a terminal server.

At 304, the broker 150 may indirectly call into the central database 160 with the request of the client 110 (e.g. to launch a word-processing program, a computer-aided design package, a spreadsheet, an accounting package, a data analysis package, a viewer, a data file, a direction-finding program, or any other suitable application). At 306, a record in the central database 160 may inform the broker 150 of the authorized connection settings for the client 110. For example, the central database 160 may indicate that the client 110 may access the requested resource on a particular terminal server (e.g. terminal server 140), and that the client 110 is prohibited from using one or more capabilities of the network 120 (e.g. clipboard redirection).

In some implementations, the broker 150 can place whatever settings it wants into the ticket store 152 for the connection with the client 110. For example, if the broker 150 decides that this particular connection should have a capability (e.g. drive redirection) disabled, it can indicate so. Additionally, the broker 150 can decide which settings to enable and disable based on a myriad of factors, including but not limited to: the identity of the user 112 requesting a connection, the terminal server the client 110 is trying to connect to, whether the client 110 is connecting through the gateway 130, whether the client 110 has passed a quarantine check to ensure that it is virus-free, the time of day, and any other suitable factors.

In some implementations, other components that are trusted and properly authenticated by the broker 150 may indicate connection settings to add or suggest to the ticket 154 at 308. For example, the gateway 130 may apply an edge-specific policy (at 308a), such as disabling “drive redirection” for all connections going through it. Another possibility is having the license server 170 certify what rights the user 112 has within a session (at 308b) from a licensing perspective to be enforced within the session (e.g. whether user is licensed to connect to a terminal server, licensed to launch *xyz* within the session, etc.). Of course, in alternate embodiments, any other suitable connection settings may be specified.

Although the process 300 has thus far been described as having the broker 150 receive all of the various connection-setting inputs from the various portions of the network 120, in alternate implementations, other components of the network 120 may perform this function, or this function may be performed by specific portions of the broker 150. For example, in some implementations, the various connection-setting inputs from the various portions of the network 120 may be received by the ticket store 152. Alternately, the connection-setting inputs may be received by the central database 160, or any other suitable component or portion of the network 120.

At 310, the broker 150 may call (or access) the ticket store 152 to obtain a ticket 154 for the client 110. In one example, the inputs to this call include the identity of the user 112, an identification of the terminal server 140 the user 112 is authorized to connect to using the ticket, the applications that the user 112 is authorized to run, a set of restrictions on the connection (e.g. “no clipboard redirection”), and the location of the client 110 (e.g. “internet”). The inputs to the ticket store 152 may also include any other connection-setting inputs provided by other components or portions of the network 120.

With continued reference to FIGS. 3 and 4, at 312, the ticket store 152 may create a ticket 154 associated with all the appropriate connection settings for the connection, and return the ticket 154 to the broker 150. Various aspects of creating the ticket 154 are described more fully below.

At 314, the broker 150 may return the ticket 154 to the client 110. In some implementations, in addition to the ticket 154, the broker 150 may also return the name of the terminal server 140 to connect to. The client 110 has everything it needs to initiate an RDP connection to the terminal server 140.

The client 110 starts the RDP connection to the terminal server 140 (via the gateway 130) and uploads the ticket 154 to the terminal server 140 through the RDP connection at 316. At 318, the terminal server 140 calls in to the broker 150 with the ticket 154, and retrieves the settings associated with the ticket 154 from the broker 150 at 320. At 322, the terminal server 140 grants (or denies) the client 110 the connection (via the gateway 130) to the desired resource 142 (e.g. a word-processing program, a computer-aided design package, a spreadsheet, an accounting package, a data analysis package, a viewer, a data file, a direction-finding program, or any other suitable application) in accordance with the settings associated with the ticket 154. The terminal server 140 may also enforce any other restrictions associated with the ticket 142 (e.g. disabling redirection).

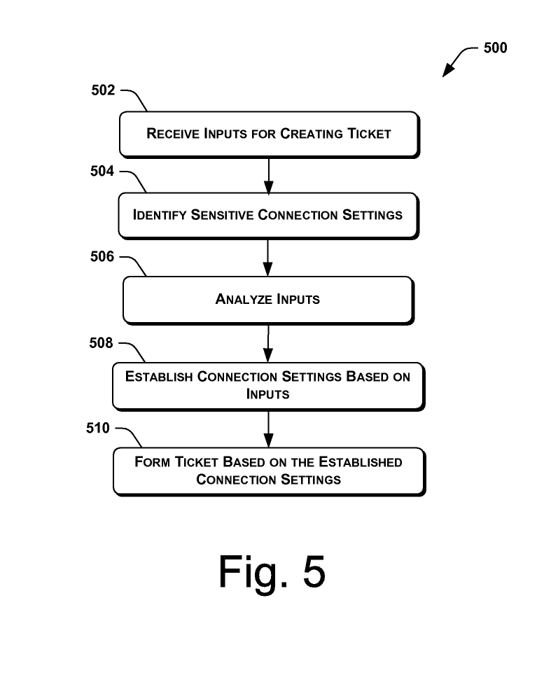

It will be appreciated that the ticket 154 may be created in a variety of suitable ways. For example, FIG. 5 shows a process 500 for creating a ticket 154 in accordance with an implementation of the present disclosure. In this embodiment, the process 500 includes receiving inputs for creating the ticket 154 at 502, As noted above, the inputs may be received from a single source (e.g. the broker 150) which has received the inputs from all the various entities and components of the network 120, or alternately, may involve receiving inputs from multiple sources, such as all the various entities and components of the network 120.

At 504, sensitive connection settings are identified. For example, in some implementations, certain connection settings are considered sensitive if they may be dangerous or risky to allow, and therefore, the various voting components of the network may want to turn them off. As a specific example, in some implementations, the feature “drive redirection” may be identified as a sensitive connection setting that must be enforced as “OFF” at the terminal server 140 if any of the voting components of the network 120 indicate a desire to have it turned off or disabled.

At 506, the inputs of the various voting components of the network are analyzed. In some embodiments, any voting component may be able to give a list of the features (or props) they want disabled or turned off, and those features (or props) not voted on by a voting component may be considered as “don't care” (or “no preference”) settings. In other words, if a voting component “doesn't care”, it may be considered equivalent to saying “I'm OK with the feature being turned on”.

At 508, the connection settings are established based on the inputs. For example, in some implementations, the connection settings are established based on Boolean logic (e.g. “AND”, “OR”, etc.) between all inputs of the voting components. Alternately, the connection settings may be established based on a hierarchy of voting components, or using any other suitable processes. As noted above, the establishment of the connection settings may be performed by the ticket store 152, or by any other suitable component of the network 120.

In the case where the connection settings are established based on Boolean logic (e.g. “AND”, “OR”, etc.) between all inputs of the voting components, it may be appreciated that the same format used by voting components to weigh-in can be reused when the terminal server 140 queries the ticket-store 152 to get the connection settings to be enforced (e.g. at 320 of FIG. 3). However, instead of getting multiple lists of suggested connection settings from the ticket store 152 (i.e. each voters' list), the terminal server 140 should receive the logical “AND” list only resulting from the establishment of the connection settings at 508.

Finally, the ticket 154 is formed at 510. It will be appreciated that the ticket 154 may take a variety of suitable forms. For example, the ticket 154 may simply contain a “key” such that when the terminal server 140 queries the broker 150, or more specifically the ticket store 152 (at 318), the terminal server 140 retrieves the connection settings from the broker 150 as described above. Alternately, the ticket 154 may contain all the appropriate connection settings (established at 508), and may be encrypted in such a way that only the terminal server 140 (and/or other components) of the network 120 can decrypt. The ticket 154 that includes all of the established connection settings may have the disadvantage that more data is sent through the client 110 (and the gateway 130), thus wasting bandwidth, however, it may afford the advantage that retrieval of the connection settings from the broker 150 (at 318) can be eliminated since the terminal server 140 can read the connection settings directly out of the ticket 154 provided by the client 110. Of course, other suitable forms of the ticket 154 may be conceived.

Techniques in accordance with the present disclosure may provide significant effects. For example, using a ticket to bind the decisions made on one server (e.g. gateway server 130) to a particular session that a client 110 or a user 112 uses to access another server (e.g. terminal server 140) provides improved security and flexibility over conventional methods of establishing connection settings. Thus, a first portion of the network 120 (e.g. the gateway server 130) can establish connection settings based on one of many criteria (including but not limited to a user identity, a client device identity, a group policy, an edge-specific policy, a connection location, a license criteria, or any other desired criteria), and another portion of the network 120 (e.g. the terminal server 140) doesn't have to know the criteria, but rather, it only needs to know the final connection settings to enforce as specified by the ticket (e.g. “disable drive redirection”).

Another advantage is that implementations in accordance with the present disclosure provide a consistent mechanism to push these connect-time decisions to the terminal server for enforcement. Thus, instead of having an array of custom protocols between the terminal server and other components of the network 120, implementations in accordance with the present disclosure may provide a well-defined interface with a single central repository where each of their decisions could be accumulated. More specifically, a ticket is used to bind the session on the terminal server to the collection of settings which is then consistently enforced throughout the network 120. Implementations in accordance with the present disclosure also provide a mechanism to enforce the connection settings desired by the gateway server 130 without having to inspect the RDP traffic passing through the gateway server 130, and further provide a mechanism to allow complex policies from various systems to be pushed to a terminal server, such that the collection of settings are bound to a particular TS session.

It should be appreciated that processes described herein, including the process 300 of FIG. 3, are intended to provide possible implementations of the present disclosure, and that the present disclosure is not limited to the particular implementations described herein and shown in the accompanying figures. For example, in alternate implementations, certain acts need not be performed in the order described, and may be modified, and/or may be omitted entirely, depending on the circumstances. Moreover, in various implementations, the acts described may be implemented by a computer, controller, processor, programmable device, or any other suitable device, and may be based on instructions stored on one or more computer-readable media or otherwise stored or programmed into such devices. In the event that computer-readable media are used, the computer-readable media can be any available media that can be accessed by a device to implement the instructions stored thereon.

Various modules and techniques may be described herein in the general context of computer-executable instructions, such as program modules, executed by one or more computers or other devices. Generally, program modules include routines, programs, objects, components, data structures, and so forth for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on or transmitted across some form of computer readable media.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method of providing connection settings, comprising:
receiving at a first network component a request from a client for access to a second network component;
creating a ticket associated with one or more connection settings associated with the request;
providing the ticket to the client;
receiving the ticket from the client at the second network component;
providing the ticket from the second network component to the first network component;
receiving at the second network component the one or more connection settings associated with the ticket from the first network component; and
enforcing the one or more connection settings at the second network component.

2. The method of claim 1, wherein the creating a ticket associated with one or more connection settings associated with the request includes accessing a central database for at least some of the one or more connection settings.

3. The method of claim 1, wherein the creating a ticket associated with one or more connection settings associated with the request includes:
accessing a central database for at least some of the one or more connection settings; and
receiving at the first network component one or more additional connection settings from one or more additional network components.

4. The method of claim 3, wherein the request from the client is communicated via a gateway, and wherein receiving at the first network component one or more additional connection settings from one or more additional network components includes receiving one or more additional connection settings associated with an edge-specific policy from the gateway.

5. The method of claim 3, wherein the receiving at the first network component one or more additional connection settings from one or more additional network components includes receiving one or more additional connection settings associated with a license from a license component.

6. The method of claim 1, wherein the first network component comprises a broker component and the second network component comprises a terminal server, and wherein the resource includes at least one of an application, a patch, an upgrade, a desktop, a directory, a documents, image, or data.

7. The method of claim 1, wherein the creating a ticket associated with one or more connection settings associated with the request includes creating a ticket based on at least one of an identity of a user, the second network component, whether the client is connecting through a gateway, whether the client has passed a quarantine check, or a time of day.

8. A system, comprising:
a first network component configured to:
receive a request from a client for access to a second network component;
create a ticket associated with one or more connection settings associated with the request; and
provide the ticket to the client;
a second network component operatively communicating with the first network component, the second network component configured to:
receive the ticket from the client;
provide the ticket to the first network component;
receive the one or more connection settings associated with the ticket from the first network component; and
enforce the one or more connection settings.

9. The system of claim 8, wherein the first network component is configured to access a central database for at least some of the one or more connection settings.

10. The system of claim 8, wherein the first network component is configured to:
access a central database for at least some of the one or more connection settings;
and
receive one or more additional connection settings from one or more additional network components.

11. The system of claim 10, wherein the request from the client is communicated to the first network component via a gateway, and wherein the first network component is configured to receive one or more additional connection settings associated with an edge-specific policy from the gateway.

12. The system of claim 10, wherein the first network component is configured to receive one or more additional connection settings associated with a license from a license component.

13. The system of claim 8, wherein the first network component comprises a broker component and the second network component comprises a terminal server, and wherein the resource includes at least one of an application, a patch, an upgrade, a desktop, a directory, a documents, image, or data.

14. A method of accessing a resource within a network, comprising:
providing a request to access a resource hosted on a first network component;
receiving a ticket created by a second network component, the ticket being associated with one or more connection settings associated with the request;
providing the ticket to the first network component; and
accessing the resource hosted on the first network component subject to the one or more connection settings enforced by the second network component.

15. The method of claim 14, further comprising:
accessing, with the second network component, a central database for at least some of the one or more connection settings; and
creating the ticket using the second network component.

16. The method of claim 15, wherein the creating the ticket using the second network component includes creating the ticket based on at least one of an identity of a user, the second network component, whether the client is connecting through a gateway, whether the client has passed a quarantine check, or a time of day.

17. The method of claim 14, further comprising:
accessing, with the second network component, a central database for at least some of the one or more connection settings;
receiving, at the second network component, one or more additional connection settings from one or more additional network components; and
creating the ticket using the second network component.

18. The method of claim 17, wherein the request to the first network component is communicated via a gateway, and wherein receiving, at the second network component, one or more additional connection settings from one or more additional network components includes receiving one or more additional connection settings associated with an edge-specific policy from the gateway.

19. The method of claim 17, wherein receiving, at the second network component, one or more additional connection settings from one or more additional network components includes receiving one or more additional connection settings associated with a license from a license component.

20. The method of claim 14, wherein the first network component comprises a terminal server and the second network component comprises a broker server, and wherein the resource includes at least one of an application, a patch, an upgrade, a desktop, a directory, a documents, image, or data.
